(19) United States
(12) Patent Application Publication
(10) Pub. No.: US 2023/0244038 A1
(43) Pub. Date: Aug. 3, 2023

(54) Ganging Clip for Very Small Form Factor Fiber-Optic Connectors

(71) Applicant: US Conec Ltd., Hickory, NC (US)

(72) Inventors: Jason Higley, Hickory, NC (US); Mitchell Cloud, Hickory, NC (US); Jillcha F. Wakjira, Hickory, NC (US); Shubhrangshu Sengupta, Hickory, NC (US); Scott Mendenhall, Hickory, NC (US)

(21) Appl. No.: 18/160,754

(22) Filed: Jan. 27, 2023

Related U.S. Application Data
(60) Provisional application No. 63/304,283, filed on Jan. 28, 2022.

(51) Int. Cl. G02B 6/36

(52) U.S. Cl. CPC G02B 6/3616

(57) ABSTRACT

A ganging clip for ganging at least two fiber-optic connectors includes a pair of side walls defining a lateral dimension of a top and having a side wall bump on an inside surface. The ganging clip also has at least one partition between the pair of side walls and extending parallel to each of the pair of side walls and extending perpendicularly from the top, a partition bump disposed on each opposite side of the at least one partition, wherein the at least two fiber-optic connectors are retained within the ganging clip at the side wall bumps and at the partition bumps.

### REFERENCE TO RELATED CASE

This application claims priority under 35 U.S.C. § 119 (e) to U.S. provisional application No. 63/304,283 filed on Jan. 28, 2022, the contents of which are hereby incorporated by reference in their entirety.

### BACKGROUND OF THE INVENTION

Hyper-scale datacenters often have a need to organize multiple data channels supported by fiber optic cables. These cables are supported by fiber-optic connectors that may be single-fiber, duplex or multi-fiber fiber-optic connectors. Recent fiber optic connections are in increasingly dense connector formats being standardized by the industry (e.g., QSFP-DD and OSFP, etc.). As a result the footprint of these fiber-optic connectors has been reducing to meet the high-density connection requirements. Generally, such fiber optic connectors are referred to as “small form factor” or “very small form factor” (VSFF) connectors.

There is a need to group or gang individual fiber-optic connectors prior to installation onto an adapter in a panel (with several similar adapters). One solution is to provide a common boot (“uniboot”) at a rear end of the housings of these fiber-optic connectors where the individual optical fibers are aggregated. One example of such a ganged uniboot is in Applicant's WIPO Publication No. WO 2021/127531 (“the '531 publication”, Atty. Dkt. USCO-126-INT). However, the solution proposed in the '531 publication leaves out the scenario where individual small form factor connectors (such as the ones shown in FIG. 14 of that publication) need to be ganged outside the tight space requirements of the adapter. Examples of such small form factor fiber-optic connectors are the MDC connector described, for example, in Applicant's Pub. No. US 2021/0149124 (Atty. Dkt. USCO-096-US, “the '124 publication”), and the MMC connector described in Applicant's WIPO Publication No. WO 2021/217057 (Atty. Dkt. No. USCO-135B-INT, “the '057 publication). The contents of the '531 publication, the '124 publication, and the '057 publication are incorporated herein by reference in their entirety.

The very small form factor fiber-optic connectors, for example, have a front side profile footprint that fits a four-port adapter, with an approximate profile for four fiber-optic connectors in the adapter (or transceiver), of 9.6 mm (height)×17.5 mm (width). A fourth such fiber-optic connector may be present next to the three connectors that are to be ganged as illustrated herein. However, the fourth connector is not ganged, as an example. The term “port” as used herein refers to a docking space for a fiber-optic connector. Thus, a “3-port” ganging clip can accommodate three such fiber-optic connectors. By way of example only, the connectors shown in the figures are MDC duplex connectors (two ferules in one fiber-optic connector). However, MMC type connectors with a miniature multi-fiber ferrule (with 8-16 fibers) could also be ganged by the ganging clip of this disclosure since the footprint of that fiber-optic connector is the same. Further, as is known in the art, the fiber-optic connectors could have ferrules that are flat polished or angle polished at the end faces. The optical fibers may be single core or multi-core, single mode or multi-mode, or combinations thereof, with 80-200 μm core-to-cladding diameter. Each fiber-optic connector has a push-pull boot with a latching mechanism, a housing, and at least two fibers supported within the housing by one or more ferrules. The latching mechanism is part of the push-pull boot.

Certain pull tab type carrier or ganging mechanism designs are used to extract individual fiber-optic connectors that are already secured inside an adapter. See, e.g., Applicant's Pub. No. US 2019/0278028 (Atty. Dkt. USCO-094). However, the extraction design proposed in that publication is not useful for ganging connectors prior to insertion into the adapter. Further, pull-tabs occupy more space and may cause fiber snagging in high-density optical interconnect environments.

Accordingly, Applicant discloses a solution to the problem of ganging individual small form factor fiber-optic connectors (MDC, MMC, or a combination of MDC and MMC connectors) prior to installing in an adapter by providing a ganging clip or ganging tool that engages or holds on to the fiber-optic connector outside the adapter space. Preferably, the ganging clip has features that engage the parts of the fiber-optic connector that remain outside the adapter even after full insertion into the adapter. Once the ganged fiber-optic connectors are fully inserted into the adapter, the ganging clip may be taken away for ganging other connectors supporting respective optical channels. The ganging clip may be of different sizes to support grouping of two fiber-optic connectors, three fiber-optic connectors, four fiber-optic connectors, or more. Typically, as many as four fiber-optic connectors are ganged in a data center scenario.

### SUMMARY OF THE INVENTION

According to one aspect, the present invention is directed to a ganging clip for ganging at least two fiber-optic connectors, each fiber-optic connector having a push-pull boot with a latching mechanism, a housing, and at least two fibers supported within the housing by one or more ferrules, the ganging clip includes a main body having a front end and a rear end, a top extending longitudinally between the front end and the rear end, a pair of side walls extending substantially perpendicular from the top on opposite edges of the top, each of the pair of side walls defining a lateral dimension of the top and having a side wall bump on an inside surface; and at least one partition between the pair of side walls and extending parallel to each of the pair of side walls and extending perpendicularly from the top, a partition bump disposed on each opposite side of the at least one partition, wherein the at least two fiber-optic connectors are retained within the ganging clip at the side wall bumps and at the partition bumps.

In some embodiments, there are also at least two projections at the rear end of the top and extending perpendicular to the top to engage a portion of the push-pull boot.

In some embodiments, the top has at least two receptacles to partially accommodate the latching mechanism of each of the respective at least two fiber-optic connectors.

In some embodiments, the receptacles extend completely through the top.

In some embodiments, the receptacles define a thinned portion of the top.

In some embodiments, each of the pair of side walls and the at least one partition include a tab extending away from the top, the tab disposed between the push-pull boot and the housing.

In some embodiments, the at least one partition comprises one partition such that two fiber-optic connectors are engageable with the ganging clip between the pair of side walls, the partition being disposed between the at least two fiber-optic connectors.

In some embodiments, that at least one partition comprises two partitions such that three fiber-optic connectors are engageable with the ganging clip between the pair of side walls, one of the three fiber-optic connectors having a partition wall on each side thereof in the lateral direction.

In some embodiments, the at least one partition comprises three partitions such that four fiber-optic connectors are engageable to the ganging clip between the pair of side walls, two of the four fiber-optic connectors having a partition wall on each side thereof in the lateral direction.

In some embodiments, the at least two projections at the rear end of the top each include a rear-facing surface to engage the respective push-pull boot of the at least two fiber-optic connectors.

In some embodiments, the side wall bumps and the partition bumps are each configured to engage an undercut in the latching mechanism of the at least two fiber-optic connectors.

In some embodiments, an underside of the top has a geometry to engage the at least two fiber-optic connectors either on a top side or on a bottom side of each of the at least two fiber-optic connectors.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a front elevational view of one embodiment of a ganging clip according to the present invention with four fiber-optic connectors;

FIG. 2 is a rear elevational view of the ganging clip and four fiber-optic connectors of FIG. 1;

FIG. 3 is a left rear perspective view of the ganging clip and four fiber-optic connectors of FIG. 1 installed in an adapter;

FIG. 4 is a front top perspective view of the ganging clip and four fiber-optic connectors of FIG. 1 outside the adapter;

FIG. 5 is a rear top perspective view of the ganging clip and four fiber-optic connectors of FIG. 1 outside the adapter

FIG. 6 is a left perspective view of the ganging clip removed from the three fiber-optic connectors of FIG. 1;

FIG. 7 is a top left perspective view of the ganging clip of FIG. 1;

FIG. 8 is a right rear perspective view of the ganging clip of FIG. 1;

FIG. 9 is a bottom perspective view of the ganging clip of FIG. 1 from the front;

FIG. 10 is a bottom perspective view of the ganging clip of FIG. 1 from the rear;

FIG. 11 is a perspective view of a cross section of the ganging clip and fiber-optic connector from the front right;

FIG. 12 is a top view of a cross section of the ganging clip and fiber-optic connectors showing the engagement of the bumps and the fiber-optic connectors;

FIG. 13 is a left perspective view of a partial cross section of the ganging clip and fiber-optic connectors of FIG. 1;

FIG. 14 is a perspective view of the ganging clip and fiber-optic connector from the bottom left with the closest fiber-optic connector removed;

FIG. 15 is a left rear perspective view of a second embodiment of a ganging clip according to the present invention with four fiber-optic connectors installed in an adapter;

FIG. 16 is a rear perspective view of the ganging clip separated from the three fiber-optic connectors of FIG. 15;

FIG. 17 is a perspective view of the ganging clip in FIG. 15 from the top left;

FIG. 18 is a perspective view of the ganging clip of FIG. 15 from the top rear;

FIG. 19 is a bottom perspective view of the ganging clip of FIG. 15 from the front;

FIG. 20 is a bottom perspective view of the ganging clip of FIG. 15 from the rear;

FIG. 21 is a front perspective view of a cross section of the ganging clip of FIG. 15 with one fiber-optic connector installed;

FIG. 22 is a left perspective view of the ganging clip and fiber-optic connectors of FIG. 15;

FIG. 23 is a perspective view of a third embodiment of a ganging clip according to the present invention from the top right;

FIG. 24 is a top view of the ganging clip of FIG. 23 attached to fiber-optic connectors installed in an adapter;

FIG. 25 is perspective view of a fourth embodiment of a ganging clip according to the present invention from the bottom front;

FIG. 26 is top left perspective view of the ganging clip in FIG. 25 connected to four fiber-optic connectors and installed in an adapter;

FIG. 27 is a perspective view of a fifth embodiment of a ganging clip according to the present invention from the bottom front;

FIG. 28 is perspective view of a sixth embodiment of a ganging clip according to the present invention from the bottom front;

FIG. 29 is a perspective view of a seventh embodiment of a ganging clip according to the present invention from the top front;

FIG. 30 is a perspective view of the ganging clip of FIG. 29 from the bottom rear;

FIG. 31 is a perspective view of a eighth embodiment of a ganging clip according to the present invention from the top rear;

FIG. 32 is a perspective view from the bottom right of the ganging clip in FIG. 31;

FIG. 33 is a perspective view from the bottom left of the ganging clip in FIG. 31 attached to fiber-optic connectors and inserted into an adapter;

FIG. 34 is left rear perspective view of the ganging clips of FIGS. 23 and 31 illustrated as engaging the housings of the fiber-optic connectors;

FIG. 35 is a perspective view of a ninth embodiment of a ganging clip according to the present invention from the top front;

FIG. 36 is a perspective view of the ganging clip in FIG. 35 from the bottom left;

FIG. 37 is a perspective view of a tenth embodiment of a ganging clip according to the present invention from the right rear; and

FIG. 38 is a perspective view of the ganging clip in FIG. 38 from the bottom right.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

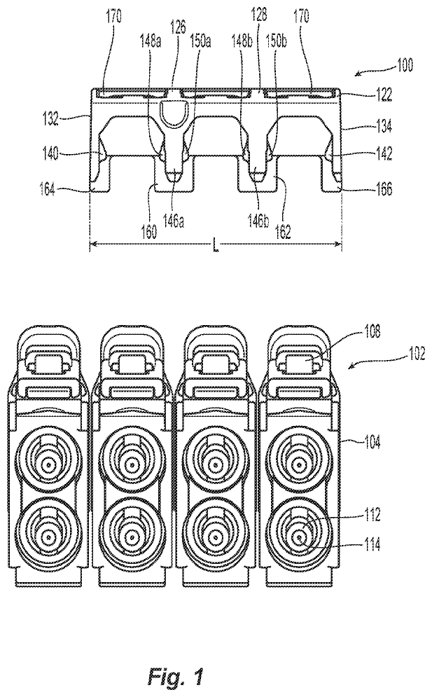

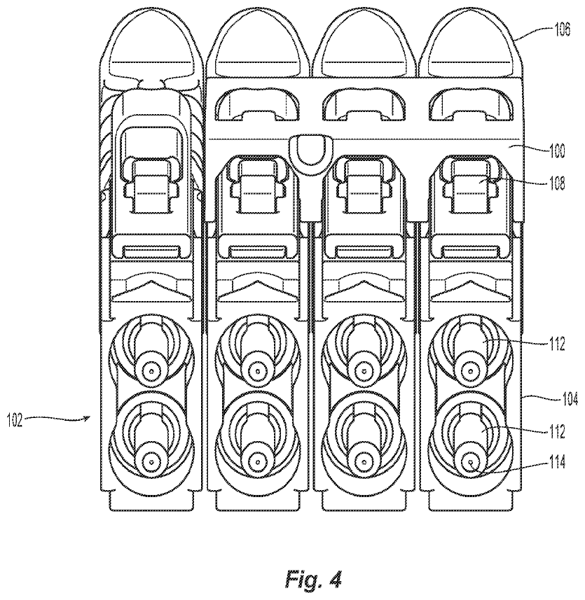

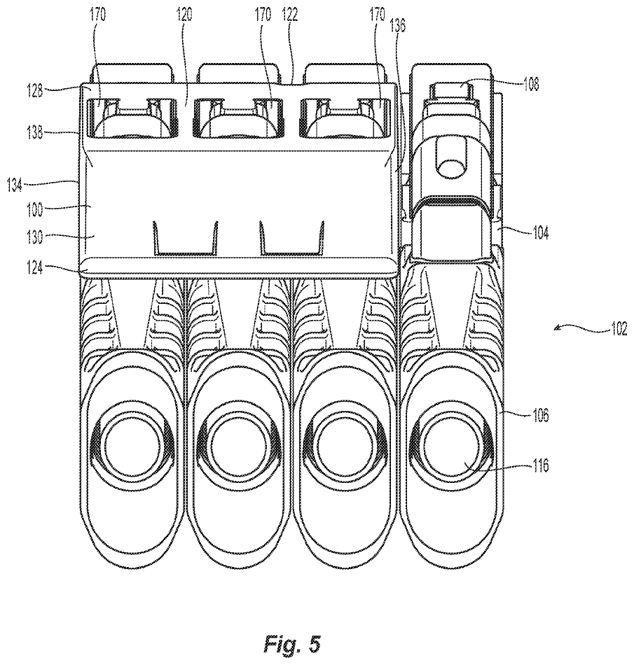

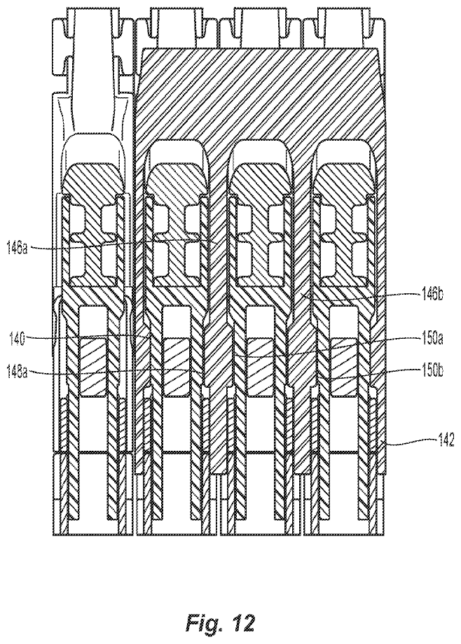

Illustrated in FIGS. 1-14 is a first embodiment of a ganging clip 100 with a number of fiber-optic connectors 102. Illustrated in the figures in this application are the MDC connector as discussed above. However, as also noted above, there are a number of different fiber-optic connectors that can be used as the fiber-optic connectors 102 with the ganging clip 100 and still fall within the scope of the present invention. Each of the fiber-optic connectors 102 preferably includes a housing 104, a push-pull boot 106 with a latching mechanism 108 to engage an adapter 110 (see, for example, FIGS. 1-5). The fiber-optic connectors 102 also preferably include one or more fiber optic ferrules 112 to support a plurality of optical fibers 114 within the housing 104. The optical fibers 114 are typically included in a fiber optic cable 116, but may also be present in other configurations. Further details of the fiber-optic connector 102 are included in the '124 publication and those details are incorporated by reference herein. The combination of the housing 104 and the latching mechanism 108 of push-pull boot 106 includes an undercut 118 that provides a place for bumps on the gangling clip 100 (discussed below) to engage and retain the fiber-optic connector 100 therein.

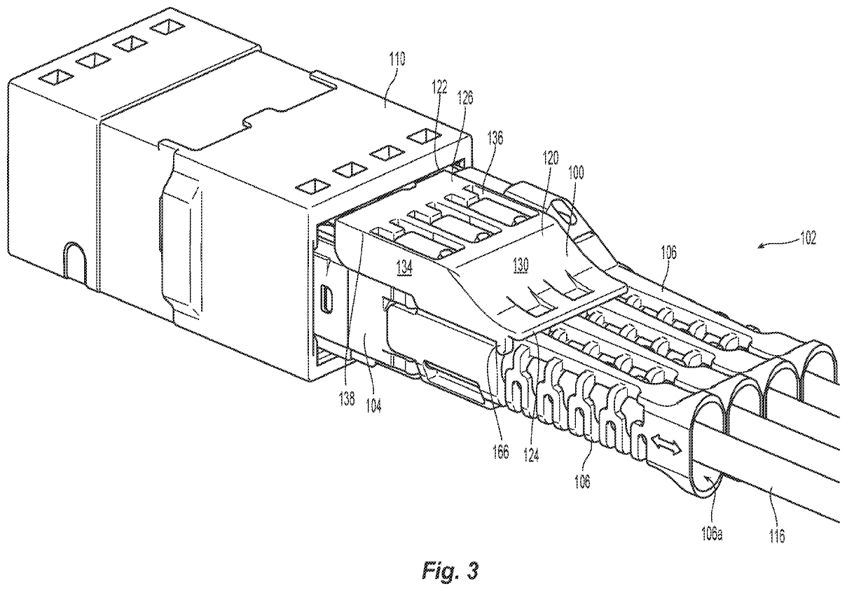

Turning now to the ganging clip 100, the ganging clip 100 has a main body 120 having a front end 122 and a rear end 124. The main body 120 has a top 126 extending longitudinally between the front end 122 and the rear end 124. The top 126 has a configuration that generally follows the configuration of the push-pull boot 106 in that it has a first portion 128 and a second portion 130. See FIGS. 3 and 6-8. However, the portions 128 and 130 may be changed to be more flat or integral with one another. The top 126 may also take on other completely different configurations as long it has the retaining or engaging features described below. The ganging clip 100 is typically used to gang or group the fiber-optic connectors 102 before they are inserted into the adapter 110. This makes it easier to insert the fiber-optic connectors 102 into the adapter 110 and assists in organizing the fiber-optic connectors 102 in the small space per the aforementioned QSFP-DD formats. The fiber-optic connectors 102 may be added to the ganging clip 100 individually or multiple fiber-optic connectors 102 can be loaded at one time. Since the ganging clip 100 remains outside the adapter 110 (see FIG. 3), the ganging clip 100 may be removed from the fiber-optic connectors 102 after they are seated in the adapter 110.

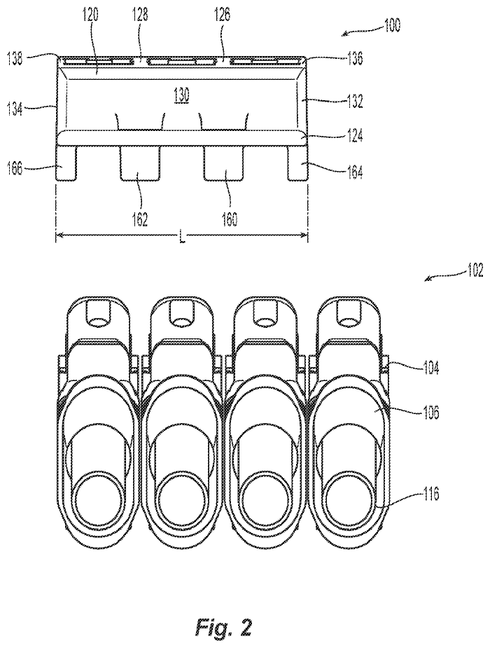

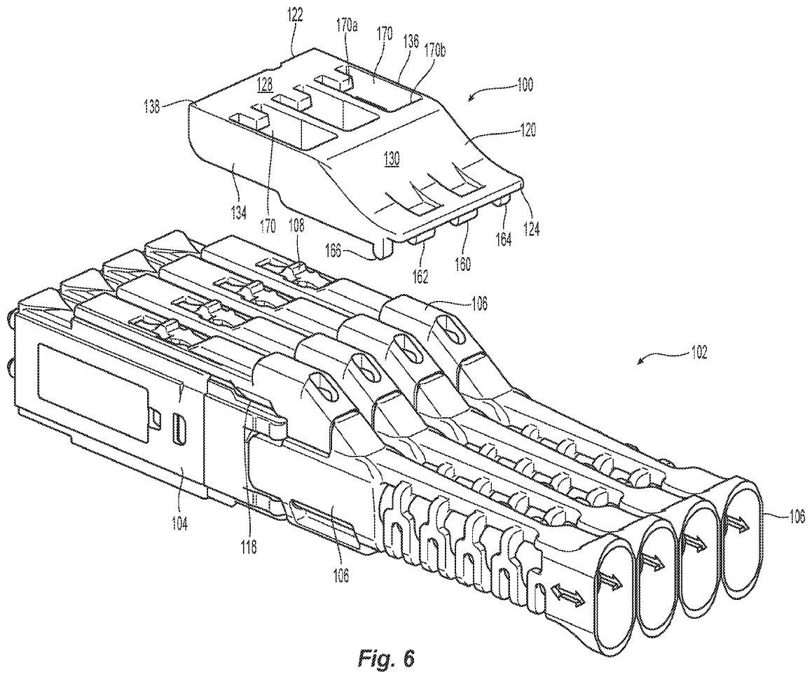

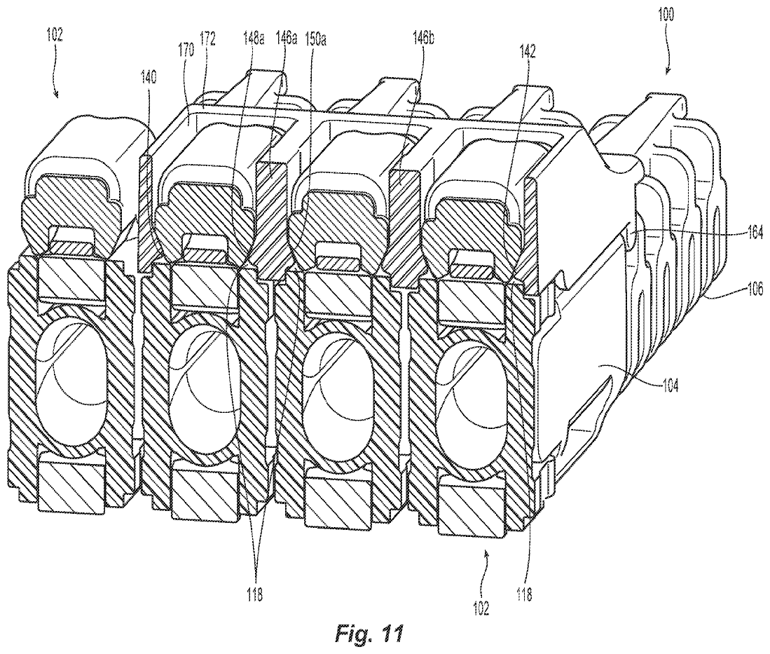

The ganging clip 100 has a pair of side walls 132,134 extending substantially perpendicularly from the top 126 on opposite edges 136,138 of the top 126, the pair of side walls 132,134 defining a lateral dimension L of the top 126 and having a side wall bump 140,142 on an inside surface 144 of the side walls 132,134. See also FIGS. 1-2. Additionally, the ganging clip 100 has at least one partition 146 between the pair of side walls 132,134 and extending parallel to each of the pair of side walls 132,134 and extending perpendicularly from the top 126. As illustrated, there are two partitions 146a and 146b in the embodiment in FIGS. 1-14, and each of the partitions 146a,146b have two partition bumps on opposing sides of the partitions 146a,146b. The partition 146a has partition bumps 148a,150a disposed on opposite sides 152a,154a thereof, and partition 146b has partition bumps 148b,150b disposed on each opposite side 152b,154b thereof. Using the side wall bumps 140,142 and the partition bumps 148a,148b,150a,150b, the fiber-optic connectors 102 are retained within the ganging clip 100. See FIGS. 6-12. For example, FIG. 11 shows the engagement between the partition bumps 140,142 with the undercut 118, and between the partition bumps 148a,148b,150a,150b with similar undercut structures on the fiber optic connectors 102.

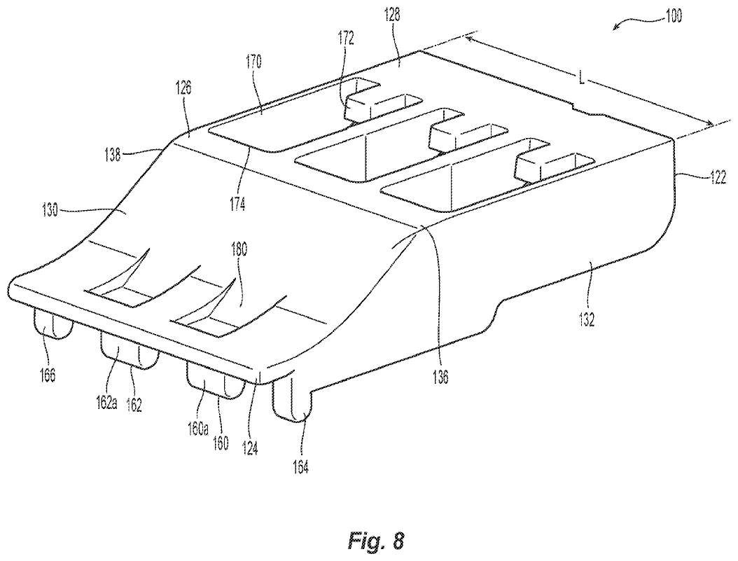

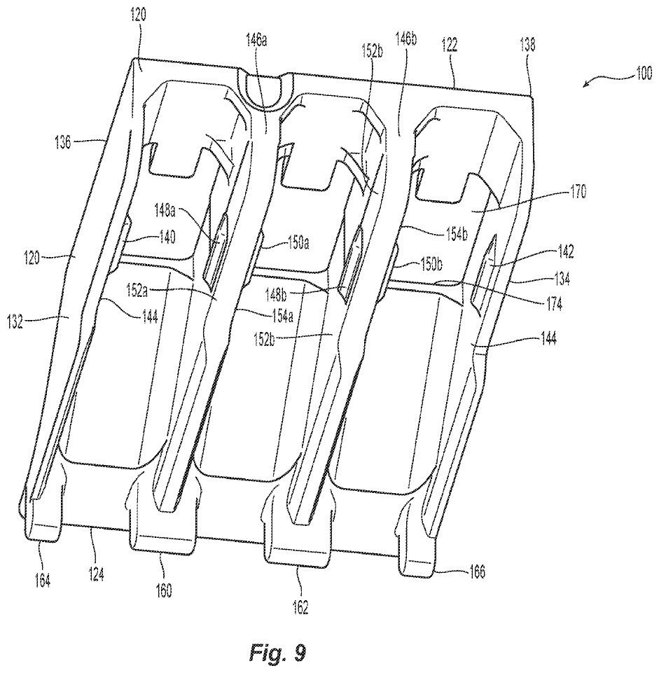

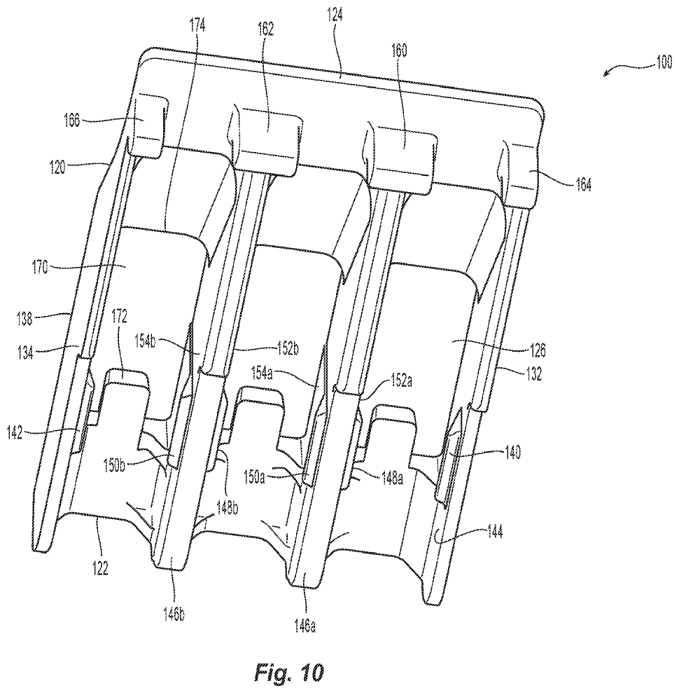

The ganging clip 100 may also include projections 160,162 near the rear end 124 of the partitions 146a,146b. See FIG. 9. Two projections 160,162 are illustrated in this embodiment, but there may be more or fewer (as with the partitions 146) depending on the number of fiber-optic connectors 102 that are to be ganged together. The projections 160,162 extend downward from the top 126 in a perpendicular orientation and have rear-facing surfaces 160a,162a to engage a forward facing portion of the push-pull boot 106. See FIG. 8. Each of the projections 160,162 are positioned between two adjacent fiber-optic connectors 102 so that they engage the push-pull boots 106 of two adjacent fiber-optic connectors 102. See FIGS. 8 and 10.

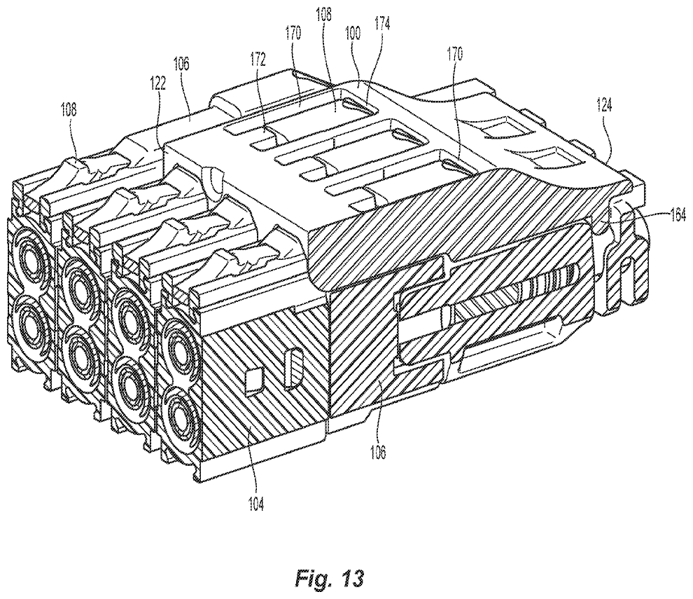

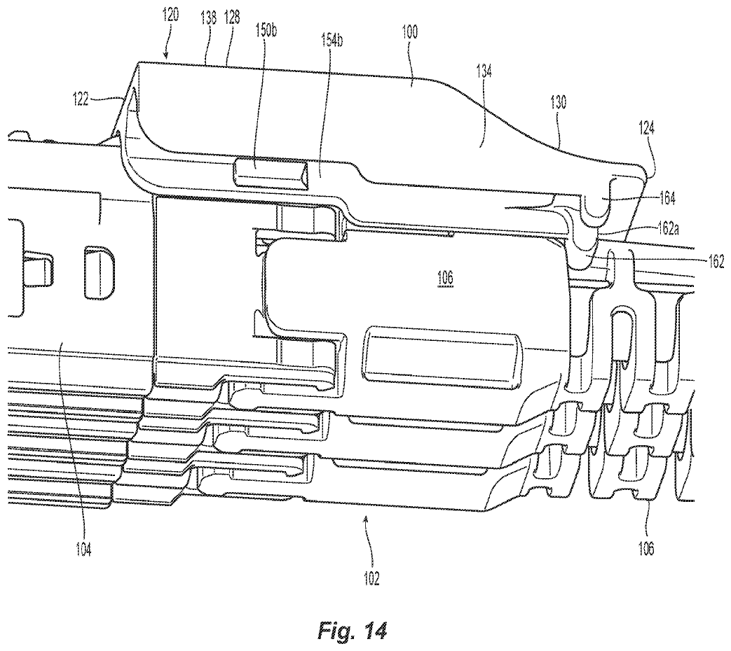

There are also two extensions 164,166 that extend downward from side walls 132,134 and also the top 126 in a perpendicular orientation to engage a different portion of the push-pull boot 106. See, e.g., FIGS. 13 and 14. Note that the extensions 164,166 are smaller than the projections 160,162 since they only engage one of the push-pull boots 106. This is due to the fact that the two extensions 164,166 are on the outside edges of the ganging clip and therefore are only exposed to one of the push-pull boots 106. See FIGS. 6 and 9. While there may be a number of projections 160,162 (1-3 depending on the number of fiber-optic connectors 102), there are either none or two of the extensions 164,166. It should also be noted that the projections 160,162 and the two extensions 164,166 are disposed forward of the rear end 124 of the main body 120. As noted above, the projections 160,162 and the two extensions 164,166 are disposed on the ganging clip 100 in a position to engage the push-pull boot 106. Thus, the projections 160,162 and the two extensions 164,166 may be moved on the ganging clip 100 to satisfy this condition.

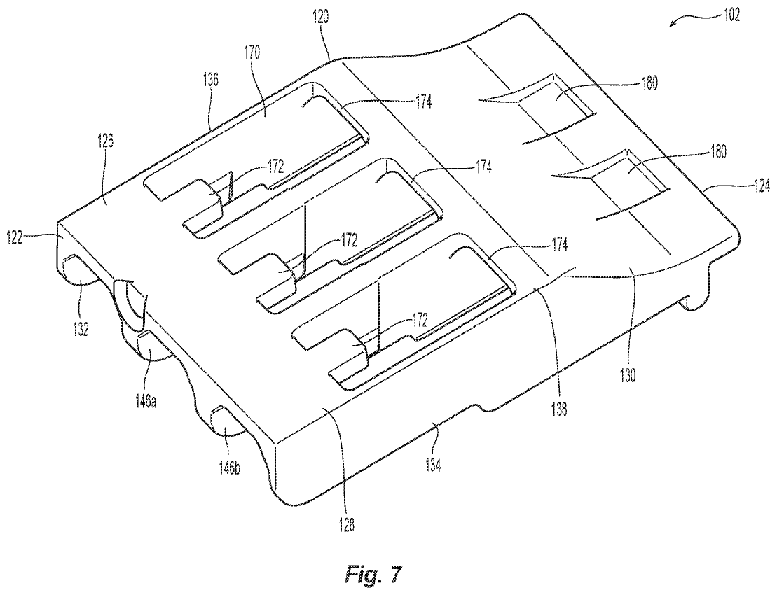

Turning back to the top 126 of the ganging clip 100, there are a number of receptacles 170 that accommodate the latching mechanism 108 of push-pull boot 106. There is preferably one receptacle for each of the fiber-optic connector 102 that are to be installed with the ganging clip 100. The receptacles 170 are illustrated as extending through the top 126, but they may be indentations and serve the same purpose without extending all the way through the top 126. The forward surface 172 and the rearward surface 174 may engage the latching mechanism 108 and assist in inserting and removing the fiber-optic connectors 102 from the adapter 110. FIGS. 7-10 and 13 show that the forward surface 172 may be on a tab that extends only partially across the receptacle 170, and engages a forward facing surface of the latch mechanism 108. However, it may also be a straight surface all the way across the receptacle 170 such as the rearward surface 174.

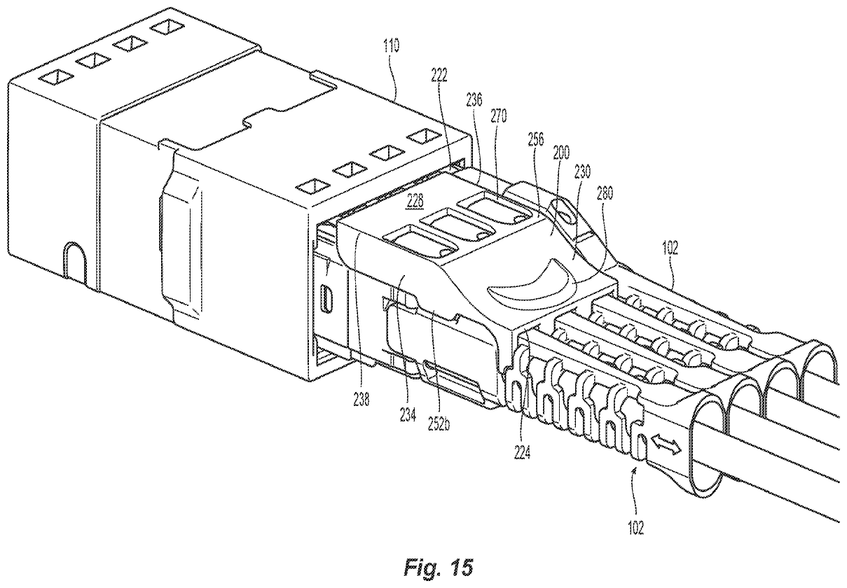

There are also two indentations 180 on the second portion 130 of the top 126 that may be used to exert pressure on the ganging clip 100 by the user during use of the ganging clip 100. However, those indentations are generally coring from the molding process but still may be used for exerting pressure or ignored completely. The coring may be located elsewhere and some other structure could be used for the same purpose. See FIG. 15 for example.

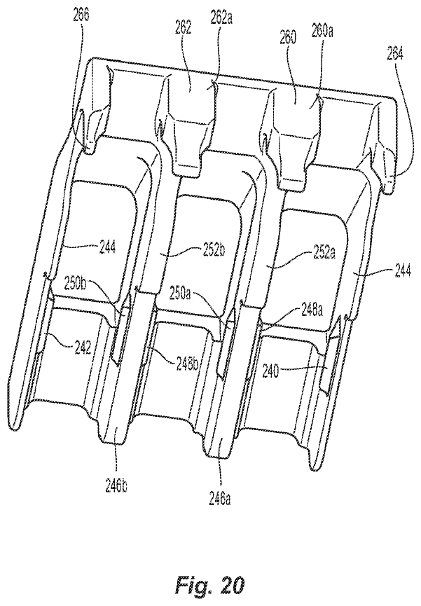

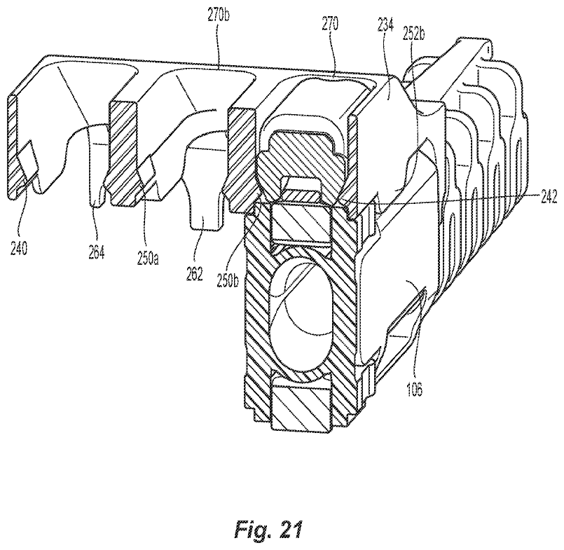

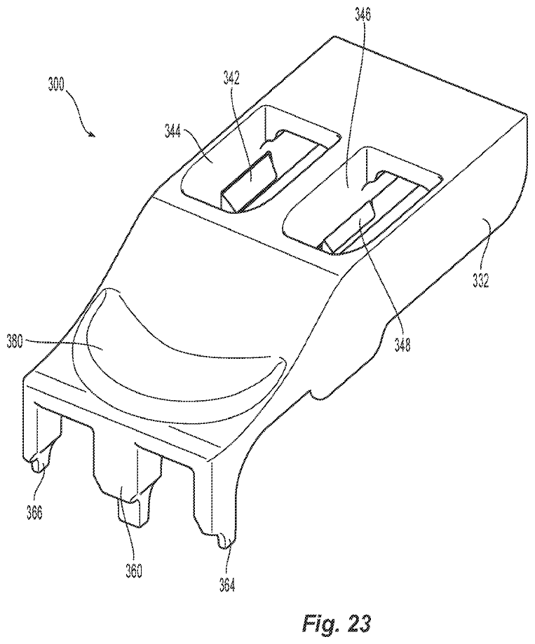

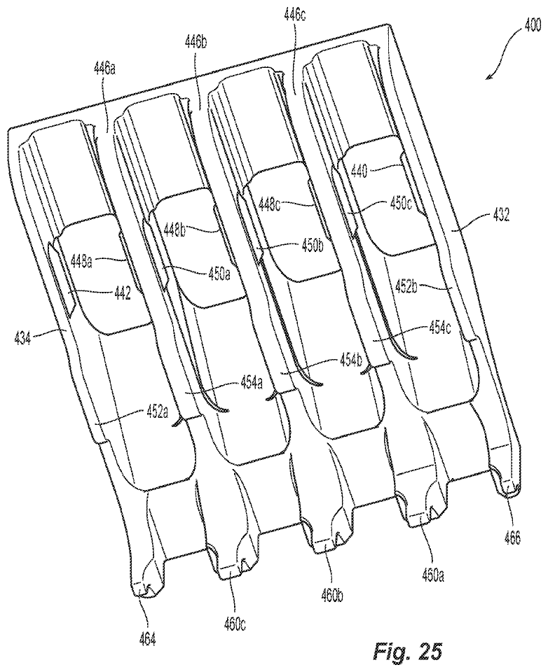

A second embodiment of a ganging clip 200 is illustrated in FIGS. 15-22. In this embodiment, the ganging clip 200 is designed to accommodate 3 fiber-optic connectors 102, but could accommodate more or fewer fiber-optic connectors 102. See, e.g., FIGS. 23 and 25. The main differences between the ganging clip 200 and the ganging clip 100 are the addition of tabs to the side walls, a different configuration of the receptacles for the latching mechanism 108, and the replacement of the indentations 180 with the thumb pad on the top rear of the main body 120.

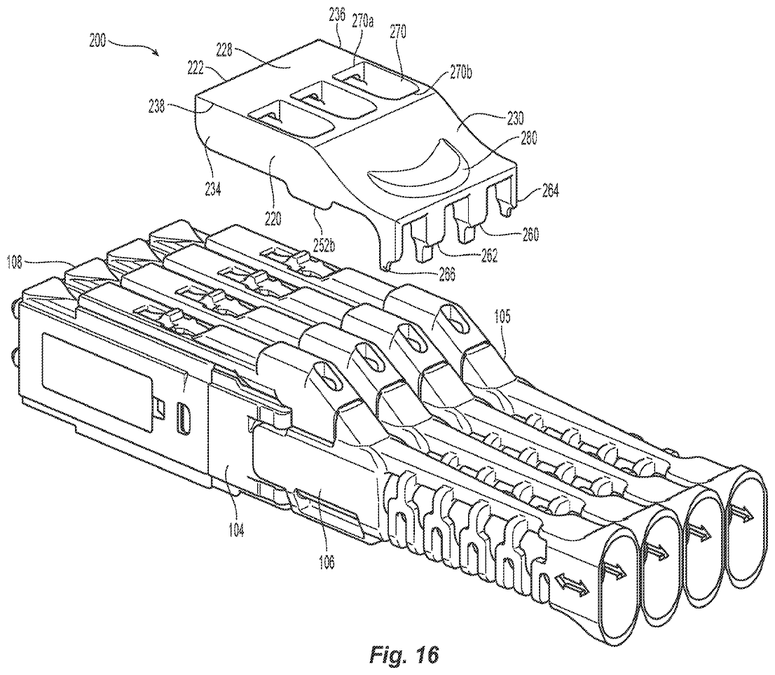

The ganging clip 200 is illustrated in FIG. 15 as being attached to three of the fiber-optic connectors 102 and the fiber-optic connectors 102 attached to the adapter 110. The ganging clip 200 has a main body 220 having a front end 222 and a rear end 224. The main body 220 has a top 226 extending longitudinally between the front end 222 and the rear end 224. The top 226 has a configuration that generally follows the configuration of the push-pull boot 106 in that it has a first portion 228 and a second portion 230. See FIGS. 16-18. However, the portions 228 and 230 may be changed to be more flat or integral with one another. The top 226 may also take on other completely different configurations as long as it has the retaining or engaging features described below. The ganging clip 200 is also used to gang the fiber-optic connectors 102 before they are inserted into the adapter 110. The fiber-optic connectors 102 may be added to the ganging clip 200 individually or multiple fiber-optic connectors 102 can be loaded at one time. Since the ganging clip 200 remains outside the adapter 110 (see FIG. 15), the ganging clip 200 may be removed from the fiber-optic connectors 102 after they are seated in the adapter 110.

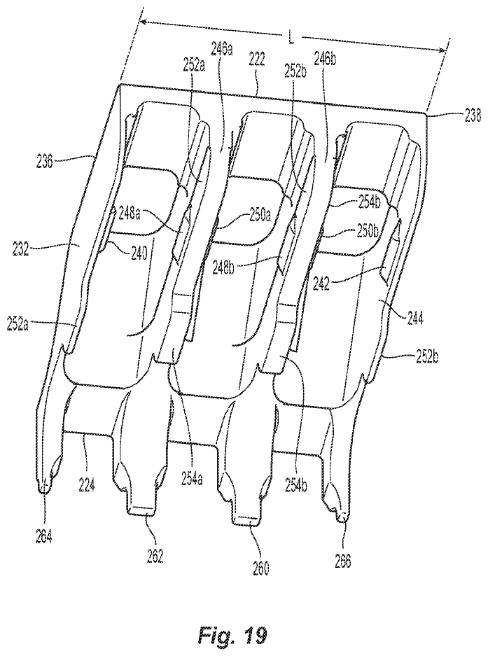

The ganging clip 200 has a pair of side walls 232,234 extending substantially perpendicularly from the top 226 on opposite edges 236,238 of the top 226, the pair of side walls 232,234 defining a lateral dimension L of the top 226 (see FIG. 19) and having a side wall bump 240,242 on an inside surface 244 of the side walls 232,234. Additionally, the ganging clip 200 has at least one partition 246 between the pair of side walls 232,234 and extending parallel to each of the pair of side walls 232,234 and extending perpendicularly from the top 226. As illustrated, there are two partitions 246a and 246b in the embodiment in FIGS. 15-22, and each of the partitions 246a,246b have two partition bumps on opposing sides of the partitions 246a,246b. The partition 246a has partition bumps 248a,250a disposed on opposite sides 252a,254a thereof, and partition 246b has partition bumps 248b,250b disposed on each opposite side 252b,254b thereof. Using the side wall bumps 240,242 and the partition bumps 248a,248b,250a,250b, the fiber-optic connectors 102 are retained within the ganging clip 100. See FIGS. 19, 20, and 22.

The ganging clip 200 also includes tabs 252a,252b that extend further downward from the pair of side walls 232,234 and tabs 254a,254b that extend downward from the two partitions 246a and 246b. The tabs 252a,252b and tabs 254a,254b are disposed to engage a top portion of the push-pull boot 106 as illustrated in FIGS. 15, 21, and 22. The engagement of the tabs 252a,252b and tabs 254a,254b with the push-pull boot 106 restricts the longitudinal movement of the ganging clip 200 with respect to the fiber-optic connectors 102 once the ganging clip 200 has been attached to the fiber-optic connectors 102. The tabs 252a, 252b are disposed longitudinally between the push-pull boot 106 and the housing 104.

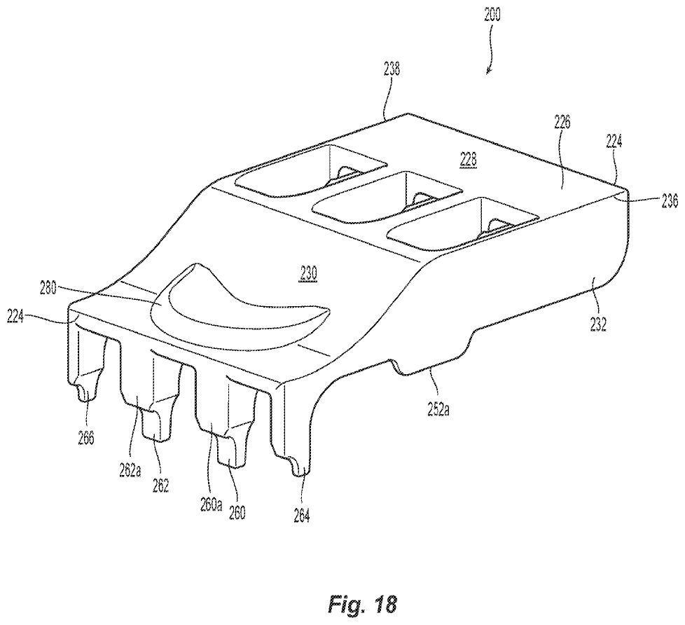

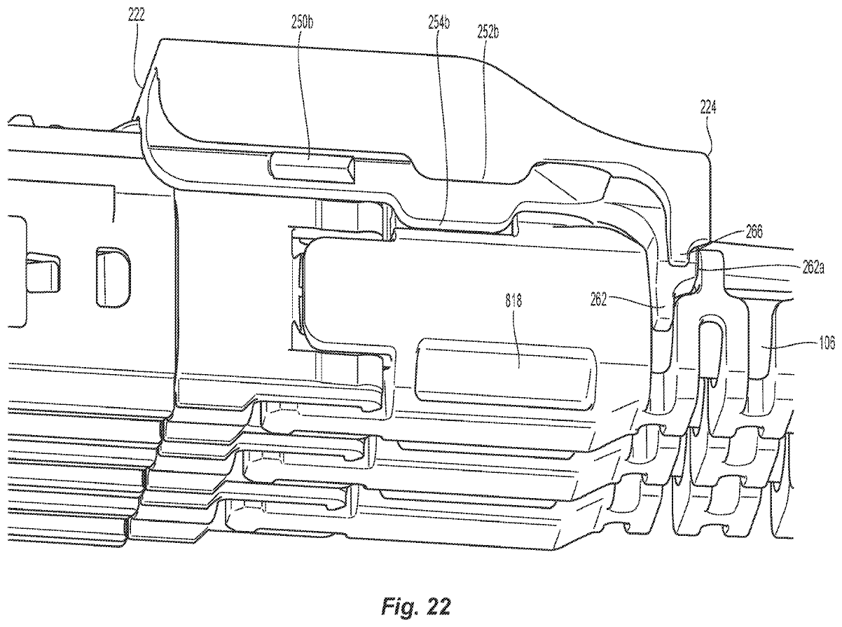

The ganging clip 200 may also include projections 260,262 at the rear end 224 of the main body 220. See FIG. 18. Two projections 260,262 are illustrated in this embodiment, but there may be more or fewer (as with the partitions 246) depending on the number of fiber-optic connectors 102 that are to be ganged together. The projections 260,262 extend downward from the top 226 in a perpendicular orientation and have rear-facing surfaces 260a,262a to engage a forward facing portion of the push-pull boot 106. See FIG. 18. Each of the projections 260,262 are positioned between two adjacent fiber-optic connectors 102 so that they engage the push-pull boots 106 of two adjacent fiber-optic connectors 102. See FIGS. 15 and 22. It should be noted that the projections 260,262 are at the rear end 224 of the main body 220. However, as with the prior embodiment, they may also be more forward on the main body 220.

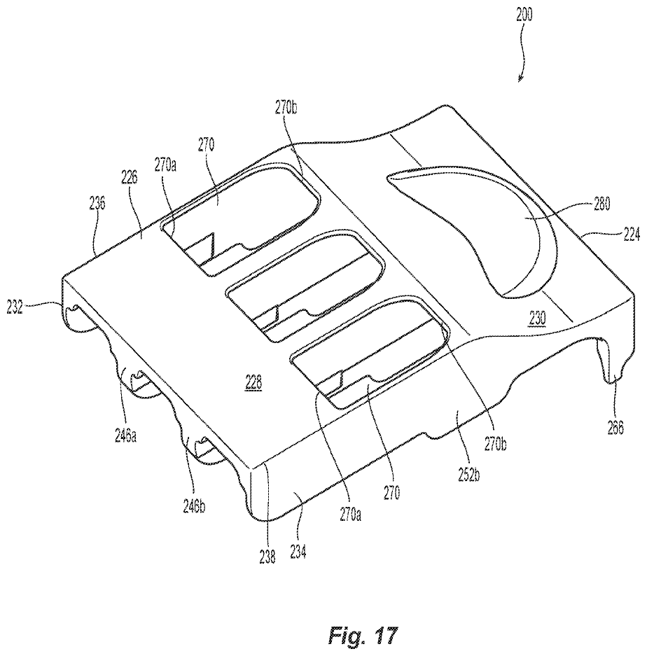

There are also two extensions 264,266 that extend downward from side walls 232,234 and also the top 226 in a perpendicular orientation to engage a different portion of the push-pull boot 106. See, e.g., FIGS. 17-19. Note that the extensions 264,266 are smaller than the projections 260,262 since they only engage one of the push-pull boots 106. This is due to the fact that the two extensions 264,266 are on the outside edges of the ganging clip 200 and therefore are only exposed to one of the push-pull boots 106. While there may be a number of projections 260,262 (1-3 depending on the number of fiber-optic connectors 102), there are either none or two of the extensions 264,266. As noted above, the projections 260,262 and the two extensions 264,266 are disposed on the ganging clip 200 in a position to engage the push-pull boot 106. Thus, the projections 260,262 and the two extensions 264,266 may be located elsewhere on the ganging clip 200 to satisfy this condition.

Referring back to the top 226 of the ganging clip 200, there are a number of receptacles 270 that accommodate the latching mechanism 108 of the push-pull boot 106. There is preferably one receptacle 270 for each of the fiber-optic connector 102 that are to be installed with the ganging clip 200. The receptacles 270 are illustrated as extending through the top 226, but they may be indentations and serve the same purpose. The forward surface 270a and the rearward surface 270b may engage the latching mechanism 108 and assist in inserting and removing the fiber-optic connectors 102 from the adapter 110. See FIGS. 17-19. While the forward surface 272 is straight across the top 226, it may also be on a tab that extends only partially across the receptacle 270 as with the prior embodiment.

There is also a thumb pad 280 on the second portion 230 of the top 256 to assist in attaching the ganging clip 200 to the fiber-optic connectors 102. Again, the thumb pad 280, while shown as a semi-circular raised portion, it could take other shapes and configurations from that illustrated here.

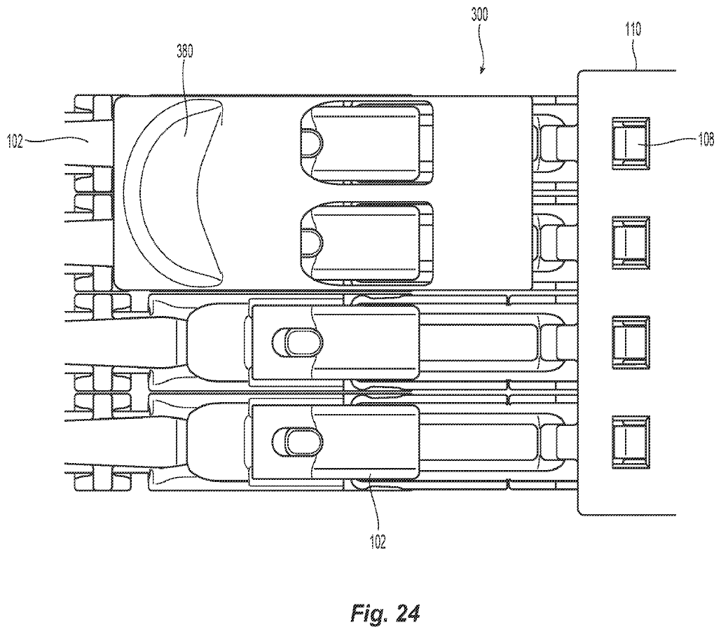

A third embodiment of a ganging clip 300 according to the present invention is illustrated in FIGS. 23 and 24. The ganging clip 300 differs from the second embodiment of ganging clip 200 in that it can accommodate only two fiber-optic connectors 102. Looking at FIG. 24, one can see that there are two fiber optic-connectors 102 connected to the ganging clip 300 while the other two fiber-optic connectors 102 are inserted directly into the adapter HO as individual units. As will be recognized, there is only one partition 346 that separates the two fiber-optic connectors 102. Similarly, the ganging clip 300 has a single projection 360 to engage the two fiber-optic connectors 102. However, the ganging clip 300 still has extensions 364,366 in a position to engage the push-pull boot 106. The ganging clip 300 also has the side wall bumps 340 (wall bump 342 shown) on an inside surface 344 of the side walls 332,334 and the partition bumps (bump 348 shown) on the partition 346.

This embodiment of ganging clip 300 in FIG. 23 also has the thumb pad 380 on the ganging clip 300. However, as with the prior embodiments, the configuration and the location of the thumb pad 380 can be moved or removed from the clip.

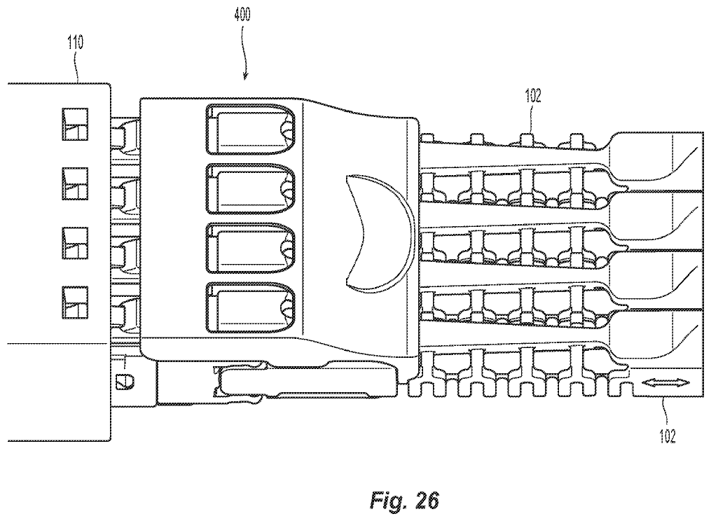

A fourth embodiment of a ganging clip 400 according to the present invention is illustrated in FIGS. 25 and 26. The gang clip 400 differs from the second and third embodiments in that it can accommodate four fiber-optic connectors 102. Looking at FIG. 26, one can see that there are four fiber optic-connectors 102 connected to the ganging clip 400 and inserted into the adapter 110. As will be recognized, there are three partitions 446a-446c that separate the four fiber-optic connectors 102. Similarly, the ganging clip 400 has three projections 460a-460c to engage the four fiber-optic connectors 102 and the two extensions 464,466 in a position to engage the push-pull boot 106. The ganging clip 400 also has the side wall bumps 440,442 on an inside surface 444 of the side walls 432,434 and the partition bumps on each of the partitions 446a-446c. That is, there are partition bumps 448a-448c and 450a-450c on the respective partitions 446a-446c. This embodiment of ganging clip 400 also includes the tabs 452a,452b that extend further downward from the pair of side walls 432,434 and tabs 454a,454b, 454c that extend downward from the partitions 446a-446c. The remainder of the ganging clip 400 has been discussed above with regard to the second and third embodiments.

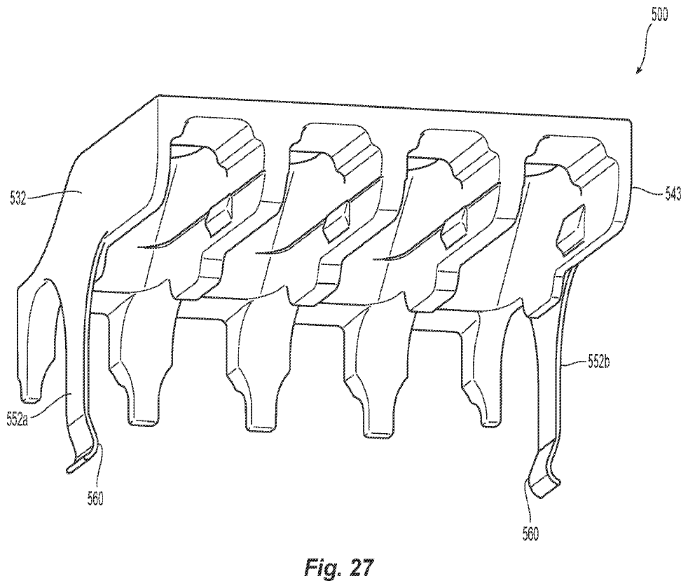

A fifth embodiment of a ganging clip 500 according to the present invention is illustrated in FIG. 27. The ganging clip 500 is the same as the fourth embodiment—ganging clip 400—but has two side extensions 552a and 552b that extend from the side walls 532,534 and terminate with a cupped portion 560. Thus, the remainder of the ganging clip 500 will not be discussed. The cupped portion 560 engages an undercut portion 818 of the push-pull boot 106. See FIG. 22 for the undercut portion 818.

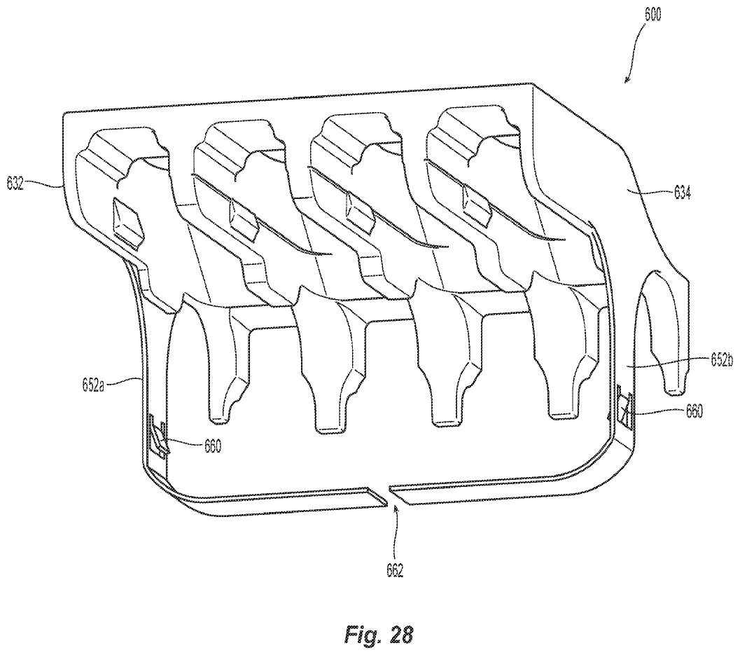

A sixth embodiment of a ganging clip 600 according to the present invention is illustrated in FIG. 28. The ganging clip 600 is the same as the fifth embodiment—ganging clip 500—but has different side extensions. In this embodiment there are two side extensions 652a and 652b that extend from the side walls 632,634 and extend around the fiber-optic connectors 102. There is preferably a gap 662 between the ends of the two side extensions 652a and 652b. The gap 662 allows for ease of installation of the ganging clip 600 around the fiber optic connectors 102. Additionally the ganging clip 600 has a tabbed portion 660 to engage the undercut portion 818 of the push-pull boot 106.

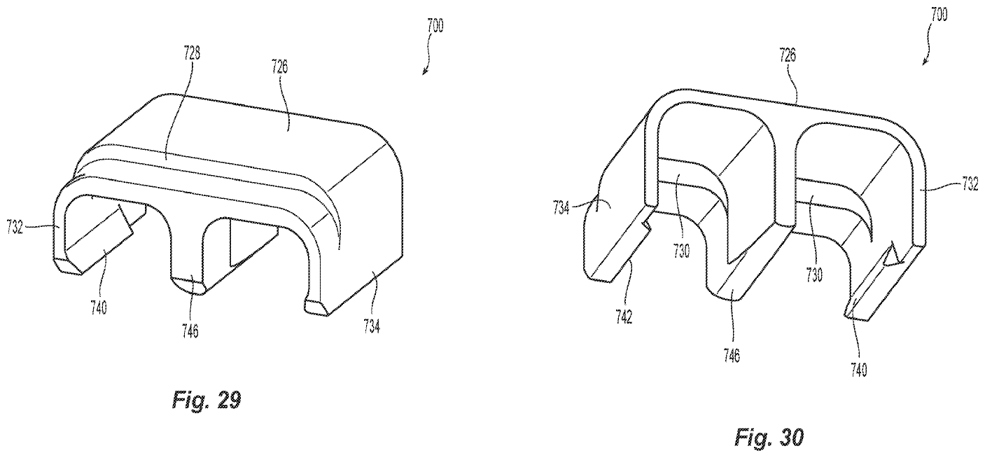

A seventh embodiment of a ganging clip 700 according to the present invention is illustrated in FIGS. 29-30. In ganging clip 700 there is a top 726 and two side walls 732,734 that extend from the top 726. There is also a partition 746 to divide the ganging clip 700 to accept two of the fiber-optic connectors 102. The sides 732,734 have bumps 740,742 that engage the undercut on the fiber optic connector 102 (it is the undercut 118 show in FIG. 6). However, the partition 746 does not have any bumps, although it is possible to include them. The ganging clip 700 has a stepped outer portion 728 that provides a rear-facing surface 730 on the inside between the two side walls 732,734 to engage the fiber-optic connector 105 or some feature on the fiber-optic connector 102—such as the latching mechanism 108 or the push-pull boot 106.

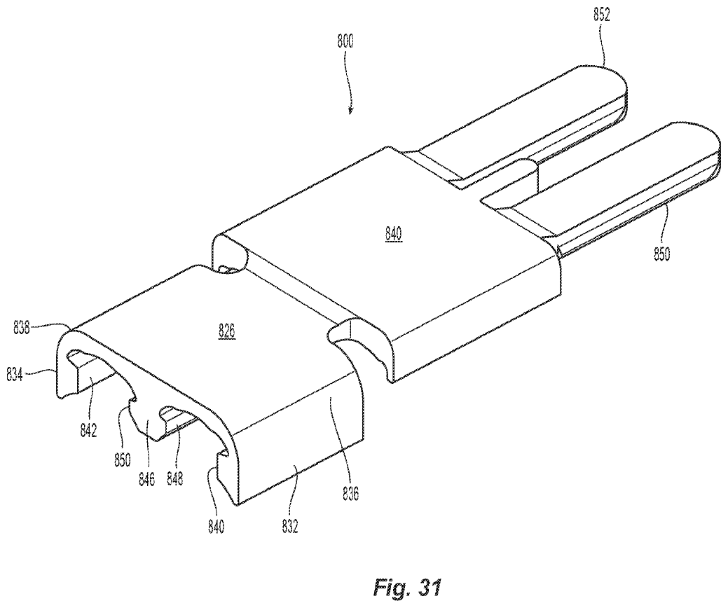

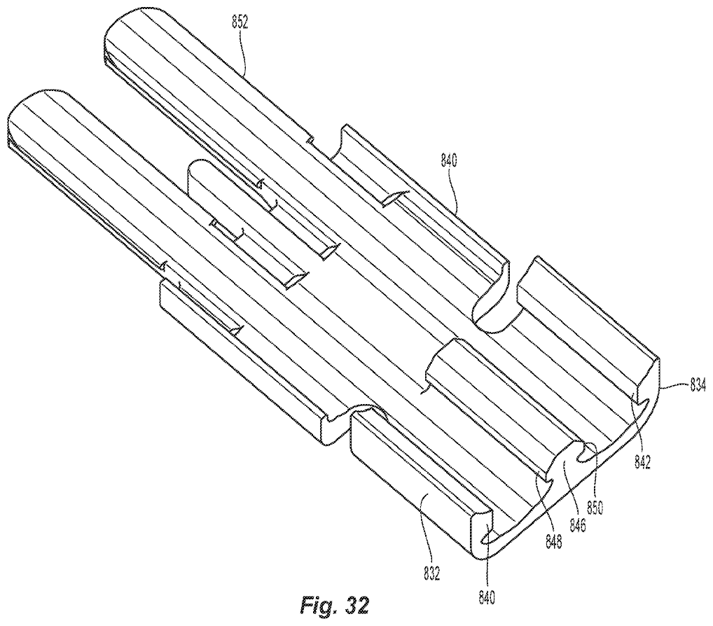

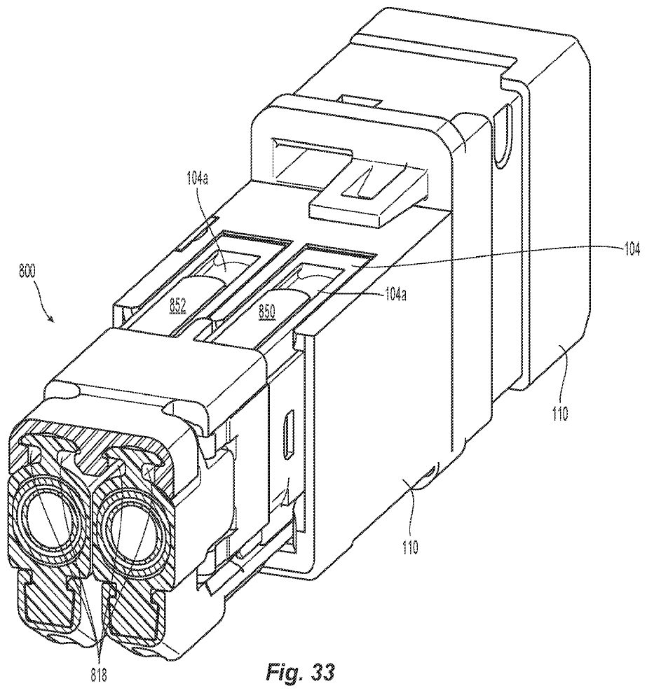

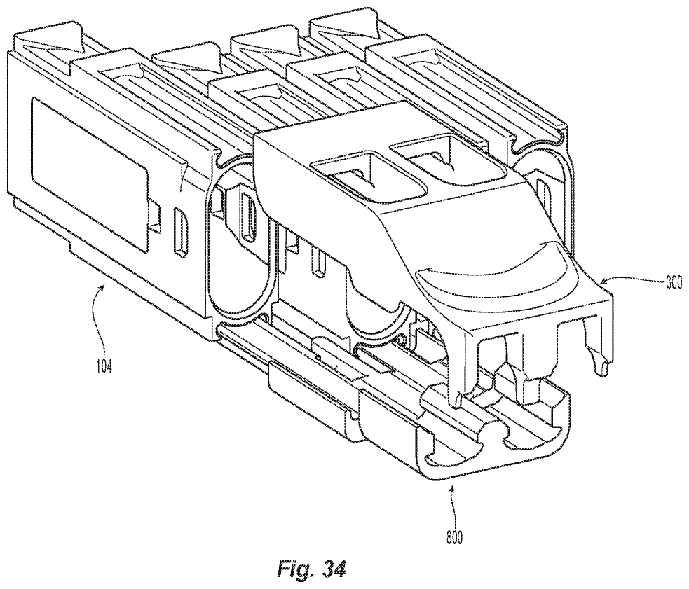

An eighth embodiment of a ganging clip 800 is illustrated in FIGS. 31-34. In this ganging clip 800, it attaches to the bottom of the fiber-optic connector 102 rather than on top as with the previous embodiments. The ganging clip 800 has a pair of side walls 832,834 extending substantially perpendicularly from the top 826 on opposite edges 836,838 of the top 826, the pair of side walls 832,834 and having a side wall bump 840,842 on the side walls 832,834. Additionally, the ganging clip 800 has one partition 846 between the pair of side walls 832,834 and extending parallel to each of the pair of side walls 832,834 and extending perpendicularly from the top 826. The partition 846 has a guide rail structures 848,850 that engage the undercut 818 on the push-pull boot 106 adjacent the bottom of the fiber-optic connector 102. See, FIG. 33. The side wall bumps 840,842 also engage the undercut 818 on fiber optic connector 102. The ganging clip 800 also has central portion 840 that extends from the top 826 toward two forward extensions 850,852 that are configured to engage guide rails 104a that are present in the housing 104. The two forward extensions 850,852 have a dove-tail construction to match the guide rails 104a in the housing 104. The two forward extensions 850,852 may be disposed within the adapter 110 as illustrated in FIG. 33. With the two forward extensions 850,852 disposed within the adapter 110, the ganging clip 800 is more secure, and it is harder to accidently separate the ganging clip 800 from the fiber-optic connectors 102. The ganging clip 800 is constructed to connecting with two fiber-optic connectors 102, but it could be constructed for three or even four fiber-optic connectors 102.

FIG. 34 illustrates the concept that the ganging clip 800 could also be used with the ganging clip 300 or 700 (not shown in figure) to more securely attach to the fiber-optic connectors 102. In this figure, the fiber-optic connectors 102 have been removed to allow the mating of the ganging clips 300 and 800 with the housings 104. While it is possible to use the ganging clip 800 by itself, it is preferable to use the ganging clip 800 with another ganging clip that is attached from the top of the fiber-optic connectors 102. An underside of the ganging clip 300 or the ganging clip 800 has a geometry to engage the at least two fiber-optic connectors 102 either on a top side or on a bottom side of each of the at least two fiber-optic connectors 102, as the use case may be.

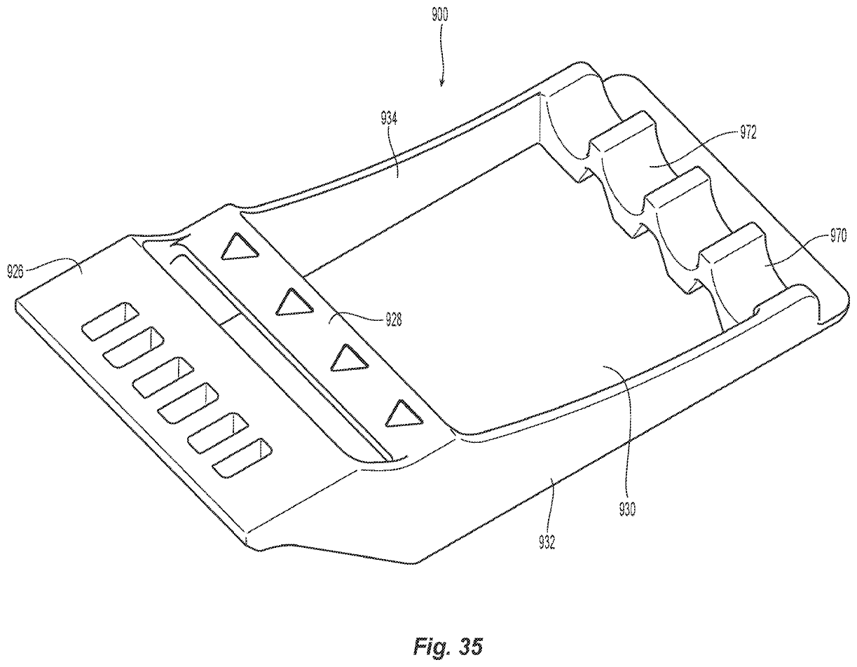

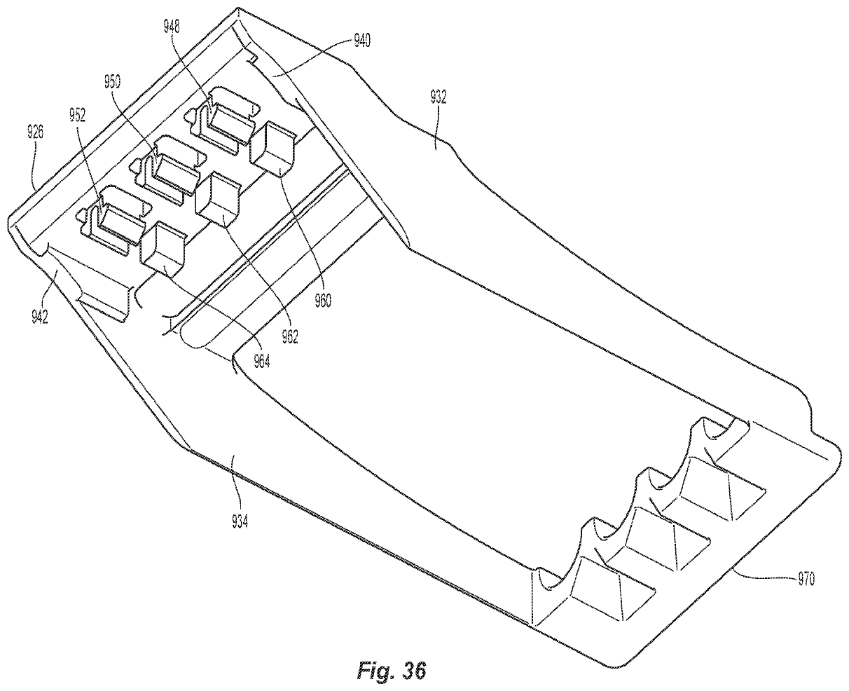

A ninth embodiment of a ganging clip 900 is illustrated in FIGS. 35 and 36. This ganging clip 900 also attaches to the bottom of the fiber-optic connectors 102. The ganging clip 900 has a pair of side walls 932,934 extending substantially perpendicularly from the top 926, the pair of side walls 932,934 and having a side wall bump 940,942 on the side walls 932,934. Additionally, the ganging clip 900 has a number of guide rail structures 948,950,952 that engage the undercut 818 on the push-pull boot 106 adjacent the bottom of the fiber-optic connector 102. See FIG. 33 wherein the prior embodiment shows the same configuration. The side wall bumps 940,942 also engage the undercut 818 on the fiber optic connector 102. The ganging clip 900 also has number of projections 960,962,964 that are disposed between the fiber-optic connectors 102 when the ganging clip 900 is attached, thereby providing more structure to retain the fiber-optic connectors 102 within the ganging clip 900. The ganging clip 900 also has a rearward support structure 970 that have curved support surfaces 972 to receive the optical fibers (not shown) that are connected to the fiber-optic cable 116. Between the side walls 932,934 there is a longitudinal member 928, which can act as a pivot point for the removal of the ganging clip 900 from the fiber optic connectors when a user lifts rearward structure 970 away from the longitudinal axis of fiber optic connectors preferably already engaged in the adapter 110. The side walls 932,934 act as a lever arm with longitudinal member 928 pivoting about a longitudinal axis and contacting the fiber-optic connectors 102 from below. Because the length between the guide rail structures 948,950,952 and the longitudinal member 928 is different than the length between the rearward structure 970 and longitudinal member 928, the force required to detach the guide rail structures 948,950,952 from the undercut 818 on the fiber-optic connector 102 is practical for a user, but other lengths are allowable. Once detached, the fiber-optic connectors 102 and fiber optic cable will be contained within hole space 930, which is bounded by longitudinal member 928, side walls 932,934, and rearward structure 970. Thus, the ganging clip 900 cannot fall or be removed completely from the fiber-optic connector assembly. It remains loosely around the fiber optic cable 116. Now the user may remove individual or multiple fiber-optic connectors 102 from the adapter 110 for cleaning or other purposes with ease by pulling on the push-pull boot 106. The user can now reinsert the fiber-optic connector 102 to its vacated port in the adapter 110 by pushing it in place until it latches. The ganging clip 900 can be reattached to all fiber-optic connectors 102 by pressing the top 926 allowing for guide rail structures 948,950,952 to re-engage the undercut 818 on the push-pull boot 106.

It should be appreciated by one of ordinary skill in the art that the top 926 may attach to the fiber optic connectors 102 in the same way as other embodiments such as the ganging clip 700. In so doing, the longitudinal member 928 may then contact the fiber optic connectors 102 from the top.

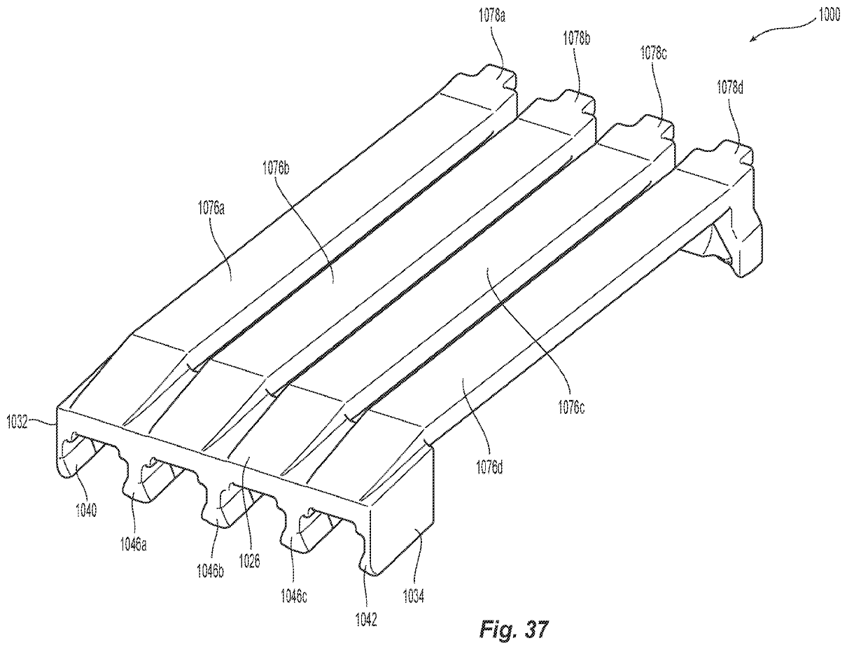

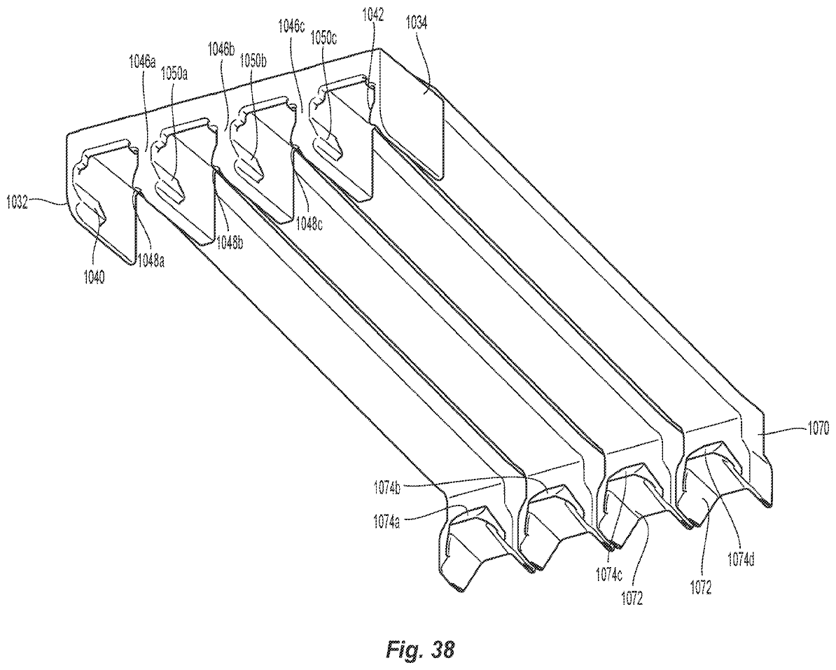

Finally, there is a tenth embodiment of a ganging clip 1000 is illustrated in FIGS. 37 and 38. The ganging clip 1000 also attaches to the top of the fiber-optic connectors 102, and in particular to the undercut 118 of push-pull boot 106. See FIG. 6. The ganging clip 1000 has a pair of side walls 1032,1034 extending substantially perpendicularly from the top 1026, the pair of side walls 1032,1034 and having a side wall bumps 1040,1042 on the side walls 1032,1034. Additionally, the ganging clip 1000 has three partitions 1046a-1046c, that have partition bumps 1048a-1048c and 1050a-1050c on the respective partitions 1046a-1046c that, along with the side wall bumps 1040,1042, engage the undercut 118 on the push-pull boot 106 on fiber-optic connector 102. See FIG. 6. The ganging clip 1000 also has a rearward support structure 1070 that have curved support surfaces 1072 to receive the optical fibers (not shown) that are connected to the fiber-optic connectors 102. On support structure 1070 there are also forward facing protrusions 1074a,1074b,1074c,1074d that engage each of the fiber-optic connectors 102 as a latching mechanism for additional retention in the back space 106a (see FIG. 3) of the push-pull boot 106. With the ganging clip 1000 attached to four fiber-optic connectors 102 in the undercut 118 and back space 106a, the ganged fiber-optic connectors 102 can be inserted into the adapter 110. While inserted, if any of the long arms 1076a,1076b,1076c,1076d are flexed away from the longitudinal axis and the push-pull boot 106 through user contact with the grip points 1078a,1078b,1078c,1078d the forward facing protrusions 1074a,1074b,1074c,1074d may be removed from its respective back space 106a. In this way a single the fiber-optic connector 102 may be pulled backward out and away from the adapter 110 individually, without the complete removal of the ganging clip 1000 from the engaged fiber-optic connectors 102. Reinserting removed fiber-optic connector 102 is possible through the normal procedure of pushing it in to its respective port in the adapter 110, which additionally re-engages partition bumps 1048a-1048c and 1050a-1050c on the respective partitions 1046a-1046c that, along with the side wall bumps 1040,1042 to the undercut 118 on the push-pull boot 106 followed by the reengagement of the forward facing protrusion 1074a,1074b,1074c,1074d into the back space 106b of the push-pull boot 106.

Applicant notes that the term “front” or “forward” as used herein means that direction where the fiber-optic connectors 102 would meet with another fiber-optic connector or device or mating ferrules inside the adapter 110, while the term “rear” or “rearward” is used to mean the direction from which the optical fibers enter into the fiber-optic ferrules 112 or the fiber-optic connectors 102. Each of the components will therefore have a front and rear, and the two respective fronts or forward portions of opposing ferrules for example, would engage one another. Thus, for example, in FIG. 3, the “front” of the fiber-optic connectors 102 is on the left side and “forward” is to the left of the page. “Rearward” or “rear” is that part of the fiber-optic connectors 102 that is on the right side of the page and “rearward” and “backward” is toward the right of the page.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A ganging clip for ganging at least two fiber-optic connectors, each fiber-optic connector having a push-pull boot with a latching mechanism, a housing, and at least two fibers supported within the housing by one or more ferrules, the ganging clip comprising:
a main body having a front end and a rear end;
a top extending longitudinally between the front end and the rear end;
a pair of side walls extending substantially perpendicular from the top on opposite edges of the top, each of the pair of side walls defining a lateral dimension of the top and having a side wall bump on an inside surface; and
at least one partition between the pair of side walls and extending parallel to each of the pair of side walls and extending perpendicularly from the top, a partition bump disposed on each opposite side of the at least one partition,
wherein the at least two fiber-optic connectors are retained within the ganging clip at the side wall bumps and at the partition bumps.

2. The ganging clip for ganging at least two fiber-optic connectors according to claim 1, further comprising at least two projections at the rear end of the top and extending perpendicular to the top to engage a portion of the push-pull boot.

3. The ganging clip for ganging at least two fiber-optic connectors according to claim 1, wherein the top has at least two receptacles to partially accommodate the latching mechanism of each of the respective at least two fiber-optic connectors.

4. The ganging clip for ganging at least two fiber-optic connectors according to claim 3, wherein the receptacles extend completely through the top.

5. The ganging clip for ganging at least two fiber-optic connectors according to claim 3, wherein the receptacles define a thinned portion of the top.

6. The ganging clip for ganging at least two fiber-optic connectors according to claim 1, wherein each of the pair of side walls and the at least one partition include a tab extending away from the top, the tab disposed longitudinally between the push-pull boot and the housing.

7. The ganging clip for ganging at least two fiber-optic connectors according to claim 1, further comprising an extension on each of the pair of side walls, each of the extensions extending down toward a bottom portion of the fiber-optic connectors.

8. The ganging clip for ganging at least two fiber-optic connectors according to claim 1, wherein the at least one partition comprises one partition such that two fiber-optic connectors are engageable with the ganging clip between the pair of side walls, the partition being disposed between the at least two fiber-optic connectors.

9. The ganging clip for ganging at least two fiber-optic connectors according to claim 1, wherein the at least one partition comprises two partitions such that three fiber-optic connectors are engageable with the ganging clip between the pair of side walls, one of the three fiber-optic connectors having a partition wall on each side thereof in the lateral direction.

10. The ganging clip for ganging at least two fiber-optic connectors according to claim 1, wherein the at least one partition comprises three partitions such that four fiber-optic connectors are engageable to the ganging clip between the pair of side walls, two of the four fiber-optic connectors having a partition wall on each side thereof in the lateral direction.

11. The ganging clip for ganging at least two fiber-optic connectors according to claim 2, wherein the at least two projections at the rear end of the top each include a rear-facing surface to engage the respective push-pull boot of the at least two fiber-optic connectors.

12. The ganging clip for ganging at least two fiber-optic connectors according to claim 1, wherein the side wall bumps and the partition bumps are each configured to engage an undercut in the latching mechanism of the at least two fiber-optic connectors.

13. The ganging clip for ganging at least two fiber-optic connectors according to claim 1, wherein the at least two fiber-optic connectors are very small form factor (VSFF) type fiber-optic connectors.

14. The ganging clip for ganging at least two fiber-optic connectors according to claim 2, wherein the at least two projections are forward of a rearmost edge of the rear end.

15. The ganging clip for ganging at least two fiber-optic connectors according to claim 1, wherein an underside of the top has a geometry to engage the at least two fiber-optic connectors either on a top side or on a bottom side of each of the at least two fiber-optic connectors.
